(19) United States
(12) Patent Application Publication
(10) Pub. No.: US 2023/0187665 A1
(43) Pub. Date: Jun. 15, 2023

(54) FUEL CELL HAVING WATER BLISTER GENERATION PREVENTION STRUCTURE AND METHOD OF MANUFACTURING THE SAME

(71) Applicants: HYUNDAI MOTOR COMPANY, SEOUL (KR); KIA CORPORATION, SEOUL (KR)

(72) Inventor: Jutae Kim, Yongin-si (KR)

(21) Appl. No.: 17/972,097

(22) Filed: Oct. 24, 2022

(30) Foreign Application Priority Data
Dec. 10, 2021 (KR) 10-2021-0176176

(51) Int. Cl. H01M 8/04291; H01M 8/1004; H01M 8/026

(52) U.S. Cl. CPC H01M 8/04291; H01M 8/1004; H01M 8/026

(57) ABSTRACT

A fuel cell having a water blister generation prevention structure, which may bond between a membrane-electrode assembly and a sub-gasket of a fuel cell by an adhesive having a water discharge passage so that the water collected at a portion between a distal end of an electrolyte membrane and the sub-gasket bonded by the adhesive or a portion between distal ends of a cathode and an anode and the sub-gasket bonded by the adhesive may be discharged to the cathode or the anode through a water discharge passage, thereby easily preventing water blister from being generated at a portion between the membrane-electrode assembly and the sub-gasket bonded by the adhesive.

### CROSS REFERENCE TO RELATED APPLICATIONS

This application claims under 35 U.S.C. § 119(a) the benefit of priority to Korean Patent Application No. 10-2021-0176176 filed on Dec. 10, 2021, the entire contents of which are incorporated herein by reference.

### BACKGROUND

### (a) Technical Field

The present disclosure relates to a fuel cell having a water blister generation prevention structure and a method of manufacturing the same, and more specifically, to a fuel cell having a water blister generation prevention structure, which may easily prevent a water blister from being generated on a bonded portion between a membrane-electrode assembly of a fuel cell and a sub-gasket, and a method of manufacturing the same.

### (b) Background Art

In general, as shown in FIG. 2, fuel cells include a polymer electrolyte membrane 11 for moving hydrogen protons, and a membrane-electrode assembly (MEA) 10 comprising catalyst layers, that is, a cathode 12 and an anode 13 that are electrode layers, which are applied to both surfaces of the electrolyte membrane so that hydrogen and oxygen may react.

In addition, although not shown in the figures, on the outer surfaces of the cathode 12 and the anode 13, a gas diffusion layer (GDL) for diffusion movement of gases such as hydrogen and air, and a separator having a flow path to supply hydrogen and air to the catalyst layer and discharge water generated by electricity generation reaction are sequentially stacked on the outer portions of the cathode 12 and the anode 13.

At this time, before the gas diffusion layer and the separator are stacked on the membrane-electrode assembly 10, as shown in FIG. 1, a sub-gasket 20 for supporting the membrane-electrode assembly 10 is bonded to four edge portions of the membrane-electrode assembly 10.

In addition, the sub-gasket 20 serves to support the membrane-electrode assembly 10 constituting each unit cell of the fuel cell, and seal a manifold that is a passage for hydrogen, air, coolant, etc. of the separator to be airtight or watertight.

To this end, an adhesive 30 is applied to an inner surface of the sub-gasket 20, and distal ends of both sides of the membrane-electrode assembly 10 come into close contact with and are bonded to the adhesive 30 applied to the sub-gasket 20.

In other words, distal ends of the cathode 12 and the anode 13 as well as a distal end of the electrolyte membrane 11 of the membrane-electrode assembly 10 are in a state of being bonded to the sub-gasket 20 by the adhesive 30 as shown in FIG. 2.

More specifically, as the distal end of the electrolyte membrane 11 extends to be longer than those of the cathode 12 and the anode 13 and the distal ends of the cathode 12 and the anode 13 are applied in a length shorter than that of the electrolyte membrane 11, as shown in FIG. 2, the adhesive 30 is in a state of being bonded to the distal end of the electrolyte membrane 11 and bonded to the distal ends of the cathode 12 and the anode 13, respectively.

After the sub-gasket 20 is bonded to the distal end of the membrane-electrode assembly 10 by the adhesive 30 as described above, the gas diffusion layer may be stacked on the cathode 12 and the anode 13 of the membrane-electrode assembly 10, and the separator may be stacked on the sub-gasket 20 and the gas diffusion layer.

For reference, a manifold 22 matched with the manifold of the separator is formed at both ends of the sub-gasket 20 so that hydrogen, air, coolant, etc. pass therethrough.

Accordingly, the driving of the fuel cell including a process of performing the oxidation reaction of hydrogen at the anode 13 to generate protons and electrons, a process of moving each of the generated protons and electrons to the cathode 12 through the electrolyte membrane 11, a process of generating water through the electrochemical reaction in which the protons and electrons moving from the anode 13 and oxygen in the air participate at the cathode 12 and generating electrical energy from the flow of electrons, etc. may be performed.

However, there is a problem in that when a lot of water is generated as a result of the electrochemical reaction at the cathode while the fuel cell is driven, the electrolyte membrane of the membrane-electrode assembly constituting each unit cell may be impregnated with water and the water may be transmitted to the distal end of the electrolyte membrane, and bonding forces for the portion between the distal end of the electrolyte membrane 11 and the sub-gasket 20 bonded by the adhesive 30 or the portion between the distal ends of the cathode 12 and the anode 13 and the sub-gasket 20 bonded by the adhesive 30 are weakened due to the transmitted water.

Furthermore, when water is continuously transmitted to the distal end of the electrolyte membrane 11, the bonding forces for the portion between the distal end of the electrolyte membrane 11 and the sub-gasket 20 bonded by the adhesive 30 or the portion between the distal ends of the cathode 12 and the anode 13 and the sub-gasket 20 bonded by the adhesive 30 may be further weakened by the continuous water pressure, and water may be continuously collected at the portion where the bonding force is weakened, thereby generating water blister.

In addition, when the volume of the water blister is increased, the hydrogen supply to the anode 13 may be cut off due to the water blister, thereby resulting in a problem such as damage to the anode due to the generation of a reverse voltage at the anode.

In addition, when the volume of the water blister is increased, the air supply to the cathode 12 may be cut off due to the water blister, thereby resulting in a problem such as the reduction in performance and output of the fuel cell due to the reduction in performance of a unit cell constituting the fuel cell.

The above information disclosed in this Background section is only for enhancement of understanding of the background of the disclosure and accordingly it may include information that does not form the prior art that is already known in this country to a person of ordinary skill in the art.

### SUMMARY

The present disclosure has been invented to solve the above conventional problems, and an object of the present disclosure is to provide a fuel cell having a water blister generation prevention structure, which may bond between a membrane-electrode assembly and a sub-gasket of the fuel cell by an adhesive having a water discharge passage so that the water collected at a portion between a distal end of an electrolyte membrane and the sub-gasket bonded by the adhesive or a portion between distal ends of a cathode and an anode and the sub-gasket bonded by the adhesive may be discharged to the cathode or the anode through the water discharge passage, thereby easily preventing water blister from being generated at the portion between the membrane-electrode assembly and the sub-gasket bonded by the adhesive, and a method of manufacturing the same.

In order to achieve the object, one embodiment of the present disclosure provides a fuel cell having a water blister generation prevention structure including a membrane-electrode assembly composed of an electrolyte membrane, and a cathode and an anode that are electrode layers applied to both surfaces of the electrolyte membrane, respectively; and a sub-gasket to which an adhesive is applied for bonding with four edge portions of the membrane-electrode assembly, in which a water discharge passage is formed over partial areas of the entire area of the adhesive applied to the sub-gasket, which are bonded to a distal end of the electrolyte membrane and distal ends of the cathode and the anode.

The water discharge passage is formed on the partial area of the entire area of the adhesive applied to the sub-gasket, and formed in the form of a groove opened toward the cathode and the anode.

In some embodiments, the water discharge passage is repeatedly formed at a predetermined interval in a width direction of the sub-gasket with a region where the adhesive is applied interposed therebetween.

In some embodiments, the water discharge passage has a polygonal groove shape or a curved groove shape with an opened one side when viewed from a planar surface, and is repeatedly formed at a predetermined interval in a width direction of the sub-gasket.

In addition, the distal ends of the cathode and the anode exposed through the water discharge passage are formed as an active area for generating electricity of the fuel cell.

Accordingly, through the water discharge passage, the water collected at a portion between the distal end of the electrolyte membrane and the sub-gasket bonded by the adhesive and a portion between the distal end of the cathode and the sub-gasket bonded by the adhesive may be discharged in an inner surface direction of the cathode, or the water collected at a portion between the distal end of the electrolyte membrane and the sub-gasket bonded by the adhesive and a portion between the distal end of the anode and the sub-gasket bonded by the adhesive may be discharged in an inner surface direction of the anode.

In order to achieve the object, another embodiment of the present disclosure provides a method of manufacturing a fuel cell having a water blister generation prevention structure, the method including an operation of being provided with an electrolyte membrane, and an membrane-electrode assembly composed of a cathode and an anode that are electrode layers applied to both surfaces of the electrolyte membrane, respectively, and an operation of applying an adhesive to a sub-gasket for bonding with four edge portions of the membrane-electrode assembly, in which when the adhesive is applied to the sub-gasket, a region where the adhesive is not formed is formed as a water discharge passage by repeating the application of the adhesive and the non-application of the adhesive over partial areas bonded to a distal end of the electrolyte membrane and distal ends of a cathode and an anode.

In some embodiments, when the adhesive is applied to the sub-gasket, the water discharge passage is repeatedly formed at a predetermined interval with a region where the adhesive is formed interposed therebetween by repeating the application of the adhesive and the non-application of the adhesive in a width direction of the sub-gasket.

In some embodiments, when the adhesive is applied to the sub-gasket, the water discharge passage has a polygonal groove shape or a curved groove shape with an opened one side when viewed from a planar surface, and is repeatedly formed at the predetermined interval with the region where the adhesive is formed interposed therebetween by repeating the application of the adhesive and the non-application of the adhesive in the width direction of the sub-gasket.

In addition, when the membrane-electrode assembly is bonded to the adhesive applied to the sub-gasket, the distal ends of the cathode and the anode are exposed through the water discharge passage and partitioned as active areas to which air and hydrogen for generating electricity of the fuel cell are supplied, respectively.

Through the above configuration, the present disclosure provides the following effects.

First, it is possible to apply the adhesive applied to the sub-gasket to bond between the electrolyte membrane of the membrane-electrode assembly and the distal ends of the electrode layers (the cathode and the anode) and the sub-gasket in the structure having the water discharge passage, thereby easily discharging the water collected at the portion between the distal end of the electrolyte membrane and the sub-gasket bonded by the adhesive or the portion between the distal ends of the cathode and the anode and the sub-gasket bonded by the adhesive through the water discharge passage in the inner surface directions of the electrode layers.

Second, it is possible to discharge water through the water discharge passage in the inner surface directions of the electrode layer, thereby easily preventing the phenomenon in which water is collected at the portion between the distal end of the electrolyte membrane and the sub-gasket bonded by the adhesive or the portion between the distal ends of the cathode and the anode and the sub-gasket bonded by the adhesive to generate water blister.

Third, it is possible to prevent the phenomenon in which the air supply to the cathode is cut off or the hydrogen supply to the anode is cut off due to the water blister, thereby preventing the damage to the anode due to the generation of the reverse voltage at the anode, and preventing the performance and output of the fuel cell from being reduced due to the reduction in performance of the unit cell constituting the fuel cell.

Fourth, the partial areas of the distal ends of the cathode and the anode matched with the water discharge passage of the adhesive may be in the opened state compared to the distal ends of the cathode and the anode covered by the adhesive for bonding with the sub-gasket conventionally, thereby increasing the active areas of the cathode and the anode for generating electricity of the fuel cell.

Fifth, it is possible to discharge water in the inner surface directions of the electrode layers dried through the water discharge passage under the drying operation conditions (low/high current regions) of the unit cell constituting the fuel cell, thereby alleviating the drying conditions of the unit cell and thus preventing the performance of the fuel cell from being reduced and the durability of the electrolyte membrane from being reduced due to the drying conditions.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

### BRIEF DESCRIPTION OF THE FIGURES

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 is a plan diagram showing a bonded state between a membrane-electrode assembly and a sub-gasket of a conventional fuel cell;

FIG. 2 is a cross-sectional diagram taken along line A-A of FIG. 1;

FIGS. 3, 4, and 5 are partial enlarged perspective diagrams sequentially showing a method of manufacturing a fuel cell having a water blister generation prevention structure according to the present disclosure;

FIG. 6 shows the fuel cell having the water blister generation prevention structure according to the present disclosure, and is a plan diagram showing a state in which the bonding between a membrane-electrode assembly and a sub-gasket is completed;

FIG. 7 is a cross-sectional diagram taken along line B-B of FIG. 6; and

FIG. 8 is a cross-sectional diagram taken along line C-C of FIG. 6.

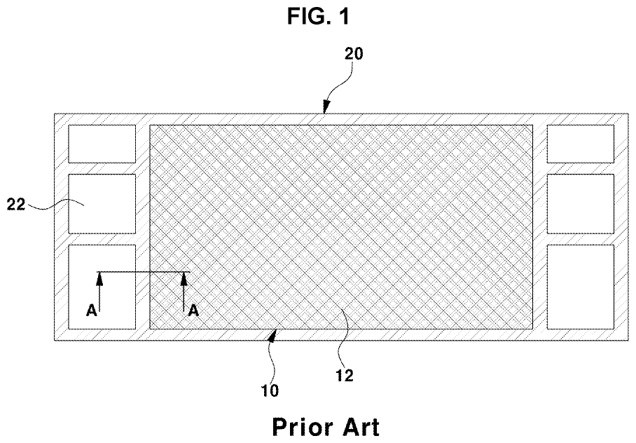

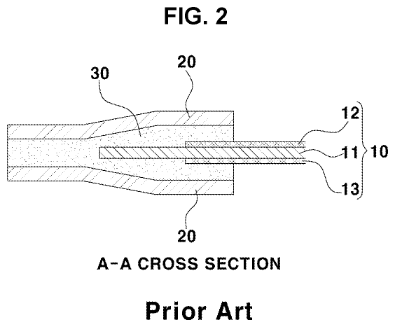

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION

Hereinafter, preferred embodiments of the present disclosure will be described in detail with reference to the accompanying drawings.

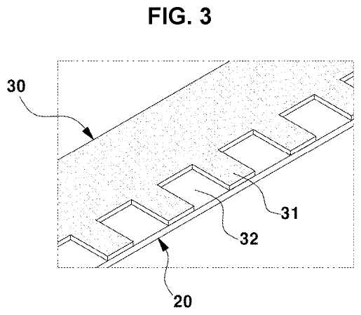

FIGS. 3 to 5 are partial enlarged perspective diagrams sequentially showing a method of manufacturing a fuel cell having a water blister generation prevention structure according to the present disclosure.

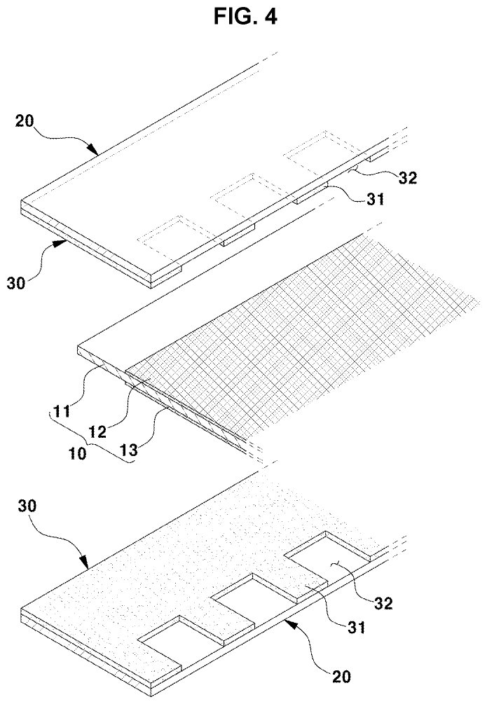

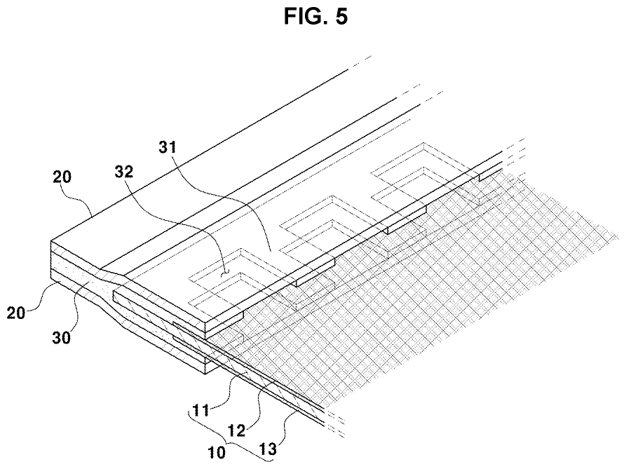

As shown in FIGS. 4 and 5, a membrane electrode assembly 10 of the fuel cell is configured to include a polymer electrolyte membrane 11 for moving protons, and a cathode 12 and an anode 13 that are electrode layers applied to both surfaces of the electrolyte membrane, respectively, so that hydrogen and oxygen may react.

Although it is not shown on outer portions of the cathode 12 and the anode 13, a gas diffusion layer for diffusion movement of gases such as hydrogen and air, and a separator having a flow path to supply hydrogen and air to the electrode layers and discharge water generated by the electricity generation reaction are sequentially stacked on the outer portions of the cathode 12 and the anode 13.

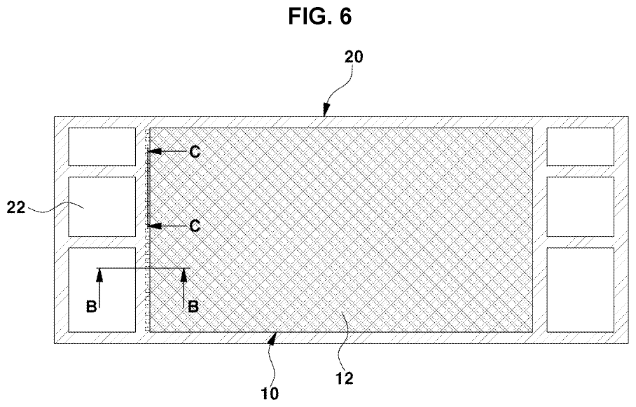

At this time, before the gas diffusion layer and the separator are stacked on the membrane-electrode assembly 10, as shown in FIG. 6, a sub-gasket 20 for supporting the membrane-electrode assembly 10 is bonded to four edge portions of the membrane-electrode assembly 10.

The sub-gasket 20 serves to support the membrane-electrode assembly 10 constituting each unit cell of the fuel cell, and seal a manifold that is a passage for hydrogen, air, cooling water, etc. of the separator to be airtight and watertight.

To this end, an adhesive 30 is applied to an inner surface of the sub-gasket 20, and distal ends of both sides of the membrane-electrode assembly 10 come into close contact with and are bonded to the adhesive 30 applied to the sub-gasket 20.

In particular, the present disclosure is characterized by applying the adhesive 30 applied to the sub-gasket 20 and bonded to a distal end of the electrolyte membrane 11 of the membrane-electrode assembly 10 and bonded to distal ends of the cathode 12 and the anode 13 in a structure having a water discharge passage 32, thereby discharging the water collected at a portion between the distal end of the electrolyte membrane 11 and the sub-gasket 20 bonded by the adhesive 30 or a portion between the distal ends of the cathode 12 and the anode 13 and the sub-gasket 20 bonded by the adhesive 30 through the water discharge passage 32 in the inner surface direction of the cathode 12 or the anode 13 that is the electrode layer.

Here, a process of bonding between the sub-gasket and the membrane-electrode assembly will be described as follows.

First, the adhesive 30 for bonding with the membrane-electrode assembly 10 is applied to an inner surface of the sub-gasket 20, and applied in the structure having the water discharge passage 32.

In other words, by repeating the application and non-application of the adhesive 30 over the inner surface of the sub-gasket 20 so that the sub-gasket is bonded to the distal end of the electrolyte membrane 11 of the membrane-electrode assembly 10 and bonded to the distal ends of the cathode 12 and the anode 13, as shown in FIG. 3, a region where the adhesive 30 is not present/formed (non-application region) may be formed as the water discharge passage 32.

In some embodiments, when the adhesive 30 is applied to the sub-gasket 20, the application of the adhesive 30 and the non-application of the adhesive 30 are repeated in a width direction of the sub-gasket 20, so that the water discharge passage 32 may be repeatedly formed at a predetermined interval with a region 31 where the adhesive is formed interposed therebetween.

In some embodiments, when the adhesive 30 is applied to the sub-gasket 20, the areas and shapes of the region 31 where the adhesive is present/applied/formed and the region where the adhesive is not present/applied/formed in the width direction of the sub-gasket 20 may be adjusted, so that the water discharge passage 32 may have a polygonal (e.g., rectangular or triangular shape) groove shape or a curved (e.g., wavy) groove shape with an opened one side when viewed from a planar surface and may be repeatedly formed at the predetermined interval with the region 31 where the adhesive is formed interposed therebetween.

At this time, as shown in FIG. 4, the membrane-electrode assembly 10 is provided in a structure including the electrolyte membrane 11, and the cathode 12 and the anode 13 that are electrode layers applied to both surfaces of the electrolyte membrane 11, respectively, and is placed between a pair of sub-gaskets 20 to which the adhesive 30 is applied as described above.

Next, the distal end of the membrane-electrode assembly 10 is bonded to the adhesive 30 applied to the sub-gasket 20.

In other words, the distal ends of the cathode 12 and the anode 13 as well as the distal end of the electrolyte membrane 11 of the membrane-electrode assembly 10 are in a state of being bonded to the sub-gasket 20 by the adhesive 30 as shown in FIG. 5.

More specifically, as the distal end of the electrolyte membrane 11 extends to be longer than those of the cathode 12 and the anode 13, and the distal ends of the cathode 12 and the anode 13 are applied in a length shorter than that of the electrolyte membrane 11, the distal end of the electrolyte membrane 11 is in a state of being bonded to the adhesive 30, and the distal ends of the cathode 12 and the anode 13 are in a state of being bonded to the region 31 where the adhesive is formed.

At this time, a part of the inside of the distal end of the electrolyte membrane 11 and parts of the distal ends of the cathode 12 and the anode 13 are in a state of not being bonded to the adhesive 30 due to the water discharge passage 32.

In other words, the part of the inside of the distal end of the electrolyte membrane 11 and the parts of the distal ends of the cathode 12 and the anode 13 are in a state of being exposed to the outside through the water discharge passage 32 without being bonded to the adhesive 30 as shown in FIG. 5.

As described above, the distal ends of the cathode 12 and the anode 13 exposed through the water discharge passage 32 may be used as active areas for generating electricity of the fuel cell.

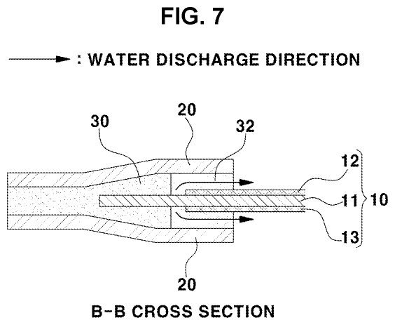

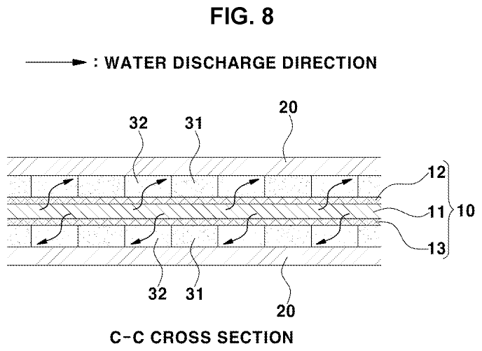

FIG. 6 shows the fuel cell having the water blister generation prevention structure according to the present disclosure and is a plan diagram showing a state in which the bonding between a membrane-electrode assembly and a sub-gasket is completed, FIG. 7 is a cross-sectional diagram taken along line B-B of FIG. 6, and FIG. 8 is a cross-sectional diagram taken along line C-C of FIG. 6.

As shown in FIGS. 6 to 8, the water discharge passage 32 is formed over partial areas of the entire area of the adhesive 30 applied to the sub-gasket 20, which are bonded to the distal end of the electrolyte membrane 11 and the distal ends of the cathode 12 and the anode 13.

As described above, when the adhesive 30 is applied to the sub-gasket 20, the water discharge passage 32 is formed by not applying the adhesive over the partial areas bonded to the distal end of the electrolyte membrane 11 and the distal ends of the cathode 12 and the anode 13.

Accordingly, the water discharge passage 32 is formed on the partial areas of the entire area of the adhesive 30 applied to the sub-gasket 20, but formed in the form of a groove opened toward the cathode 12 and the anode 13.

More specifically, when the adhesive 30 is applied in the width direction of the sub-gasket 20 as described above, the water discharge passage 32 is repeatedly formed at a predetermined interval with the region 31 where the adhesive is formed interposed therebetween by alternating the application of the adhesive 30, but has a polygonal (e.g., rectangular or triangular shape) groove shape or a curved (e.g., wavy) groove shape with an opened one side when viewed from a planar surface and is repeatedly formed at the predetermined interval with the region 31 where the adhesive is formed interposed therebetween.

In addition, as shown in FIG. 7, the water discharge passage 32 has a path overlapping the distal ends of the cathode 12 and the anode 13 so that water may be directly discharged to the cathode 12 and the anode 13.

Meanwhile, while the fuel cell is driven, the electrolyte membrane 11 of the membrane-electrode assembly 10 constituting each unit cell of the fuel cell may be impregnated with water, the water may be transmitted to the distal end of the electrolyte membrane 11, and the water generating water blister may be collected at the portion between the distal end of the electrolyte membrane 11 and the sub-gasket 20 bonded by the adhesive 30 or the portion between the distal ends of the cathode 12 and the anode 13 and the sub-gasket 20 bonded by the adhesive 30 due to the transmitted water.

Accordingly, the water collected at the portion between the distal end of the electrolyte membrane 11 and the sub-gasket 20 bonded by the adhesive 30 or the portion between the distal ends of the cathode 12 and the sub-gasket 20 bonded by the adhesive 30 may be discharged in the inner surface direction of the cathode 12 through the water discharge passage 32, thereby easily preventing water blister from being generated.

More specifically, since the portion between the distal end of the cathode 12 and the sub-gasket 20 bonded by the adhesive 30 has water collected therein and is in a wet state, whereas the inner surface of the cathode 12 is in a drier state, the water collected at the portion between the distal end of the cathode 12 and the sub-gasket 20 bonded by the adhesive may be discharged to the inner surface of the cathode 12 in a flow that is naturally wet through the water discharge passage 32 as indicated by arrows in FIGS. 7 and 8, thereby easily preventing water blister from being generated.

In addition, the water collected at the portion between the distal end of the electrolyte membrane 11 and the sub-gasket 20 bonded by the adhesive 30 and the portion between the distal end of the anode 13 and the sub-gasket 20 bonded by the adhesive 30 may be discharged in the inner surface direction of the anode 13, thereby easily preventing water blister from being generated.

More specifically, since the portion between the distal end of the anode 13 and the sub-gasket 20 bonded by the adhesive 30 has water collected therein and in a wet state, whereas the inner surface of the anode 13 is in a drier state, the water collected at the portion between the distal end of the anode 13 and the sub-gasket 20 bonded by the adhesive may be discharged in the flow that naturally wets the inner surface of the anode 13 through the water discharge passage 32 as indicated by arrows in FIGS. 7 and 8, thereby easily preventing water blister from being generated.

Furthermore, the water may be discharged in the inner surface directions of the cathode and the anode that are the electrode layers dried through the water discharge passage 32 under the drying operation conditions (low/high current regions) of the unit cell constituting the fuel cell, thereby alleviating the drying conditions of the unit cell and thus preventing the performance of the fuel cell from being reduced by the dry conditions and the durability of the electrolyte membrane from being reduced.

Meanwhile, as described above, the membrane-electrode assembly 10 is bonded to the adhesive 30 applied to the sub-gasket 20, and then the partial areas of the distal ends of the cathode 12 and the anode 13 are exposed to the outside through the water discharge passage 32, so that the active areas of the cathode 12 and the anode 13 to which air and hydrogen for generating electricity of the fuel cell are supplied, respectively, may be increased, and the performance of the fuel cell may also be proportional to the active areas, thereby improving the performance of the fuel cell.

While one embodiment of the present disclosure has been described above in detail, the scope of the present disclosure is not limited to the above-described embodiment, and various modifications and improvements by those skilled in the art using the basic concept of the present disclosure defined in the appended claims will be included in the scope of the present disclosure.

1. A fuel cell having a water blister generation prevention structure comprising:
a membrane-electrode assembly having an electrolyte membrane including a first surface and a second surface;
a cathode electrode layer applied to the first surface of the electrolyte membrane, and an anode electrode layer applied to the second surface of the electrolyte membrane; and
a sub-gasket to which an adhesive is applied for bonding with four edge portions of the membrane-electrode assembly;
wherein a plurality of discharge passages are formed in alternate areas at the edge of the sub-gasket, where the adhesive applied to the sub-gasket are partially cut out, and wherein the electrolyte membrane, the cathode, and the anode as overlapped and bonded together.

2. The fuel cell having the water blister generation prevention structure of claim 1, wherein the water discharge passage is formed on the partial area of the entire area of the adhesive applied to the sub-gasket, and formed as a groove opened toward the cathode and the anode.

3. The fuel cell having the water blister generation prevention structure of claim 2, wherein the plurality of water discharge passages are formed alternately along the edge of the sub-gasket with areas of the adhesive formed therebetween.

4. The fuel cell having the water blister generation prevention structure of claim 2, wherein the plurality of water discharge passages are alternately formed along an edge, in a width direction, of the sub-gasket, each of the plurality of water discharge passages being formed as a groove having a polygonal or curved shape.

5. The fuel cell having the water blister generation prevention structure of claim 1, wherein each of the plurality of water discharge passages is formed to have a path overlapping the distal ends of the cathode and the anode.

6. The fuel cell having the water blister generation prevention structure of claim 1, wherein the distal ends of the cathode and the anode exposed through each of the water discharge passages are formed as an active area for generating electricity of the fuel cell.

7. The fuel cell having the water blister generation prevention structure of claim 1, wherein through each of the plurality of water discharge passages, water collected at a portion between the distal end of the electrolyte membrane and the sub-gasket bonded by the adhesive and a portion between the distal end of the cathode and the sub-gasket bonded by the adhesive is discharged in an inner surface direction of the cathode, or water collected at a portion between the distal end of the electrolyte membrane and the sub-gasket bonded by the adhesive and a portion between the distal end of the anode and the sub-gasket bonded by the adhesive is discharged in an inner surface direction of the anode.

8. A method of manufacturing a fuel cell having a water blister generation prevention structure, the method comprising:
providing an electrolyte membrane, and an membrane-electrode assembly composed of a cathode and an anode that are electrode layers applied to both surfaces of the electrolyte membrane; and
applying an adhesive to a sub-gasket for bonding with four edge portions of the membrane-electrode assembly;
wherein when the adhesive is applied to the sub-gasket, a region where the adhesive is not applied is formed as a water discharge passage by alternatively applying the adhesive over partial areas bonded to a distal end of the electrolyte membrane and distal ends of the cathode and the anode.

9. The method of claim 8, wherein when the adhesive is applied to the sub-gasket, a plurality of water discharge passages are alternately formed at predetermined intervals with a region where the adhesive is applied interposed therebetween by alternating the application of the adhesive in a width direction of the sub-gasket.

10. The method of claim 9, wherein when the adhesive is applied to the sub-gasket, the plurality of water discharge passages have a polygonal groove shape or a curved groove shape with an opened side, and are alternately formed at the predetermined intervals with the region where the adhesive is applied interposed therebetween by alternating the application of the adhesive in the width direction of the sub-gasket.

11. The method of claim 8, wherein the membrane-electrode assembly is bonded to the adhesive applied to the sub-gasket, the distal ends of the cathode and the anode are exposed through the plurality water discharge passages and partitioned as active areas to which air and hydrogen for generating electricity of the fuel cell are supplied.
